(19) United States
(12) Patent Application Publication
(10) Pub. No.: US 2011/0299802 A1
(43) Pub. Date: Dec. 8, 2011

(54) FLUID-SUPPORTED THRUST BEARINGS

(75) Inventor: Neil West, Corona, CA (US)

(73) Assignee: NATIONAL OILWELL VARCO, L.P., Houston, TX (US)

(21) Appl. No.: 13/115,203

(22) Filed: May 25, 2011

Related U.S. Application Data
(60) Provisional application No. 61/352,000, filed on Jun. 7, 2010.

(51) Int. Cl. F16C 32/06

(52) U.S. Cl. 384/107

(57) ABSTRACT

A thrust bearing allows a first structure to rotate relative to a second structure about an axis of rotation while supporting an axial load between the first structure and the second structure. In an embodiment, the thrust bearing comprises a first annular bearing race slidingly disposed in a first annular recess in the first structure. In addition, the thrust bearing comprises a second annular bearing race engaging the second structure. Further, the thrust bearing comprises a plurality of circumferentially spaced roller elements axially disposed between the first bearing race and the second bearing race. The roller elements contact the first bearing race and the second bearing race. The first bearing race and the first recess define a first annular fluid cavity axially positioned between the first bearing race and the first structure. The first bearing race rides on a fluid disposed in the first fluid cavity.

### CROSS-REFERENCE TO RELATED APPLICATIONS

This application claims benefit of U.S. provisional patent application Ser. No. 61/352,000 filed Jun. 7, 2010, and entitled “Fluid-Supported Thrust Bearing,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

This invention relates generally to mechanical bearings. More particularly, the invention relates to apparatus and methods for supporting mechanical bearings with fluids.

2. Background of the Technology

In general, mechanical bearings are devices that limit or constrain relative motion between two or more parts, typically rotation or linear movement. Mechanical bearings are used in a myriad of different applications. There are a variety of different types of mechanical bearings including ball bearings, roller bearings, ball thrust bearings, roller thrust bearings, tapered roller thrust bearings, and the like. Selecting a particular type of bearing usually depends on the specific application.

Different types of bearings differ significantly with respect to the magnitude and direction of forces they can support. For example, some bearings are designed to support forces in a radial direction, axial direction, or a combination of the two. Bearings that allow relative rotation between parts, while simultaneously supporting forces in an axial direction are typically referred to as “thrust bearings.” Most conventional thrust bearings include roller elements such as balls or rollers that ride on one or more races.

In certain cases, a structure that supports a bearing may deflect or deform under load. This may create “hot spots” in the bearing that may result in the uneven distribution of forces across the bearing. Such uneven distribution of forces can lead to undesirable wear, uneven wear, and/or uneven loading in the bearing, which may in turn reduce the bearing's useful life or make it more susceptible to failure.

Accordingly, there remains a need in the art for apparatus and methods to more evenly distribute forces across bearings supporting structures that deflect under load or provide uneven support.

### BRIEF SUMMARY OF THE DISCLOSURE

These and other needs in the art are addressed in one embodiment by a thrust bearing that allows a first structure to rotate relative to a second structure about an axis of rotation while supporting an axial load between the first structure and the second structure. In an embodiment, the thrust bearing comprises a first annular bearing race slidingly disposed in a first annular recess in the first structure. In addition, the thrust bearing comprises a second annular bearing race engaging the second structure. Further, the thrust bearing comprises a plurality of circumferentially spaced roller elements axially disposed between the first bearing race and the second bearing race. The roller elements contact the first bearing race and the second bearing race. The first bearing race and the first recess define a first annular fluid cavity axially positioned between the first bearing race and the first structure. The first bearing race rides on a fluid disposed in the first fluid cavity.

These and other needs in the art are addressed in another embodiment by an apparatus. In an embodiment, the apparatus comprises a first structure and a second structure rotatably coupled to the first structure. The second structure is adapted to rotate relative to the first structure about an axis of rotation. In addition, the apparatus comprises a thrust bearing axially disposed between the first structure and the second structure. The thrust bearing comprises a plurality of circumferentially-spaced roller elements disposed about the axis of rotation. The thrust bearing also comprises a first bearing race in contact with the plurality of roller elements. Further, the apparatus comprises a first fluid cavity axially disposed between the first structure and the first bearing race. Moreover, the apparatus comprises a fluid in the first fluid cavity configured to transfer axial loads between the first structure and the first bearing race.

These and other needs in the art are addressed in another embodiment by a method for supporting an axial load between a first structure and a second structure and allowing the first structure to rotate relative to the second structure about an axis of rotation. In an embodiment, the method comprises (a) placing a thrust bearing axially between the first structure and the second structure. The thrust bearing comprises a first annular bearing race axially adjacent the first structure. The thrust bearing also comprises a second annular bearing race axially adjacent the second structure. Still further, the thrust bearing comprises a plurality of circumferentially spaced roller elements axially disposed between the first bearing race and the second bearing race. The roller elements contact the first bearing race and the second bearing race. In addition, the method comprises (b) forming an annular fluid cavity axially between the first bearing race and the first structure. Further, the method comprises (c) filling the fluid cavity with a fluid. Moreover, the method comprises (d) transferring the axial load between the first bearing race and the first structure through the fluid in the fluid cavity.

Thus, embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a partial cross-sectional view of an embodiment of a fluid-supported thrust bearing in accordance with principles described herein;

FIG. 2 is a partial cross-sectional view of the fluid-supported thrust bearing of FIG. 1 including a flow channel in communication with the fluid cavity;

FIG. 3 is a partial cross-sectional view of an embodiment of a fluid-supported thrust bearing in accordance with the principles described herein;

FIG. 4 is a partial cross-sectional view of an embodiment of a fluid-supported thrust bearing in accordance with the principles described herein and including ball bearing roller elements;

FIG. 5 is a partial cross-sectional view of an embodiment of a fluid-supported thrust bearing in accordance with the principles described herein and including cylindrical roller elements;

FIG. 6 is a perspective view of an exemplary device including the fluid-supported thrust bearing of FIG. 1;

FIG. 7 is a cross-sectional view of the device of FIG. 6;

FIG. 8 is an enlarged cross-sectional view of the device of FIG. 6; and

FIG. 9 is a perspective cross-sectional view of the device of FIG. 6.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

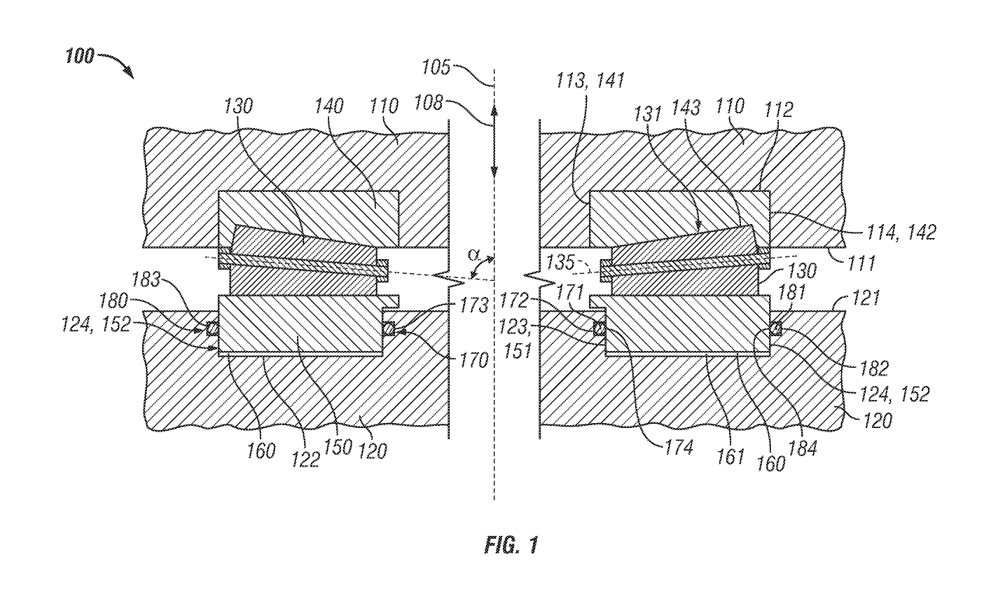

Referring now to FIG. 1, a cross-sectional view of an embodiment of a fluid-supported thrust bearing 100 in accordance with the principles described herein is shown. Thrust bearing 100 is a mechanical, rotary bearing that allows relative rotation between two parts while supporting axial loads between the parts. As shown in FIG. 1, thrust bearing 100 allows a first or upper structure 110 to rotate relative to a second or lower structure 120 about an axis of rotation 105 while simultaneously supporting axial loads 108 between structures 110, 120. In this embodiment, thrust bearing 100 bears the weight of the upper structure 110 (i.e., axial load 108 represents the weight of structure 110) while allowing structures 110, 120 to rotate relative to one another about axis 105. In general, structures 110, 120 may comprise any two parts or components of a device, piece of equipment, or hardware that rotate relative to each other and transmit axial loads such as a shaft and housing.

In this embodiment, fluid-supported thrust bearing 100 includes a plurality of circumferentially spaced roller elements 130, a first or upper annular race 140, and a second or lower annular race 150. Upper race 140 is axially disposed between upper structure 110 and roller elements 130, and axially supports upper structure 110, and lower race 150 is axially disposed between lower structure 120 and roller elements 130, and is axially supported by lower structure 120. Roller elements 130 contact and roll along races 140, 150.

In this embodiment, thrust bearing 100 is a tapered roller thrust bearing, and thus, each roller element 130 is a tapered roller element having an axis of rotation 135 oriented at an acute angle α relative to axis 105 and a frustoconical radially outer surface 131. A projection of each axis 135 intersects axis 105. As will be described in more detail below, in other embodiments, the fluid-supported thrust bearing (e.g., bearing 100) may be a ball thrust bearing with ball bearing roller elements or a non-tapered roller thrust bearing with cylindrical roller elements.

Referring still to FIG. 1, upper structure 110 has an outer surface 111 opposed lower structure 120 that includes an annular recess 112 extending radially from a radially inner cylindrical surface 113 to a radially outer cylindrical surface 114. Upper bearing race 140 is seated in recess 112 and engages surfaces 113, 114. In other words, upper bearing race 140 has a radially inner cylindrical surface 141 that engages surface 113 and a radially outer cylindrical surface 142 that engages surface 114. Upper bearing race 140 also includes an annular recess 143 that receives roller elements 130.

During operations, upper structure 110 supported by a bearing race 140 or lower structure 120 that supports bearing race 150 may, in certain cases, deflect or deform under load. Such deflection may result in “hot spots” in thrust bearing 100 that cause the uneven distribution of forces bearing 100. Without a means or mechanism to counter the uneven distribution of loads, bearing 100 may experience undesirable and/or uneven wear, potentially reducing the useful life of bearing 100. However, in this embodiment, bearing 100 is a fluid-supported thrust bearing configured to ride or float on a thin layer of fluid 160 to more evenly distribute forces between lower structure 120 and the corresponding lower bearing race 150. In this embodiment, fluid 160 resides in an annular cavity or cavity 161 axially disposed between lower bearing race 150 and structure 120. In particular, lower structure 120 has an outer surface 121 opposed upper structure 110 that includes an annular recess 122 extending radially from a radially inner cylindrical surface 123 to a radially outer cylindrical surface 124. Lower bearing race 150 is at least partially disposed in recess 122 and slidingly engages surfaces 123, 124. In other words, lower bearing race 150 has a radially inner cylindrical surface 151 that slidingly engages surface 123 and a radially outer cylindrical surface 152 that slidingly engages surface 124. Fluid 160 is disposed in recess 122 axially between lower bearing race 150 and lower structure 120. Thus, bearing race 150 and structure 120 are designed and configured to form annular cavity 161 therebetween; fluid 160 is disposed in cavity 161. Since fluid 160 is flowable and defomable (i.e., fluid 160 is not a rigid solid), fluid 160 offers the potential to more evenly distribute forces between structure 120 and bearing race 150, thereby reducing and/or eliminating “hot spots.” In general, fluid 160 may comprise any incompressible or lower compressibility fluid suitable for the temperature and pressure demands of the particular application. Examples of suitable fluids include, without limitation, hydraulic fluid, water, oil, and rubber, which behaves like a liquid at relatively high pressures. In this embodiment, fluid 160 is hydraulic fluid.

A pair of seal assemblies 170, 180 are provided to restrict and/or prevent fluid 160 in cavity 161 from flowing axially between bearing race 150 and structure 120, and leaking from cavity 161. More specifically, a first or radially inner sealing assembly 170 is provided between opposed surfaces 151, 123, and a second or radially outer sealing assembly 180 is provided between opposed surfaces 152, 124. In this embodiment, each seal assembly 170, 180 includes an annular seal member 171, 181, respectively, seated in an annular recess or seal gland 172, 182, respectively, in structure 120. Gland 172 extends radially inward from surface 123, and gland 182 extends radially outward from surface 124. Seal member 171 is disposed in gland 172 and is radially compressed between bearing race 150 and structure 120, thereby forming an annular static seal 173 with structure 120 and an annular dynamic seal 174 with bearing race 150. Seal member 181 is disposed in gland 182 and is radially compressed between bearing race 150 and structure 120, thereby forming an annular static seal 183 with structure 120 and an annular dynamic seal 184 with bearing race 150. Thus, each seal member 171, 181 sealingly engages lower bearing race 150 and structure 120. Bearing race 150 functions similar to an annular piston disposed in annular recess 122. Thus, in general, seal members 171, 181 may comprise any suitable annular piston-type seals. In this embodiment, each seal member 171, 181 is an energized U-cup hydraulic seal. However, in other embodiments, the seal members (e.g., seal members 171, 181) may comprise annular piston rings, O-ring seals, or other suitable hydraulic seals.

Although annular seal members 171, 181 are seated in glands 172, 182 in structure 120, in other embodiments, the seal members (e.g., seal members 171, 181) may be seated in seal glands (e.g., glands 172, 182) formed on the radially inner and radially outer surfaces, respectively, of the lower bearing race (e.g., surfaces 151 and 152 of bearing race 150). In such embodiments, each seal member sealingly engages the lower bearing race and the lower structure (e.g., structure 120). In particular, an annular static seal is formed between each seal member and the lower bearing race, and a dynamic seal is formed between each seal member and the lower structure.

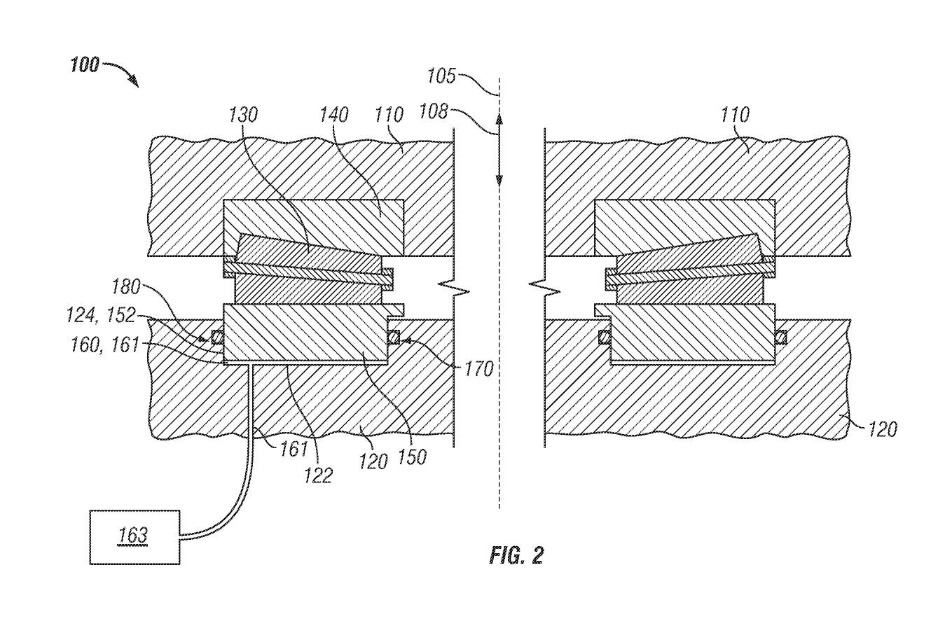

Referring now to FIG. 2, in some cases, it may be advantageous to have access to cavity 161 and fluid 160 therein. Accordingly, a flow channel or passage 162 in fluid communication with cavity 161 may be provided. Here, flow channel 162 extends through structure 120 to cavity 161 positioned between lower bearing race 150 and lower structure 120. Channel 162 may be employed to bleed fluid(s) from cavity 161. For example, channel 162 may be employed to bleed fluid 160 from cavity 161 on an as-needed basis. This may allow fluid 160 to be removed from cavity 161 (to replace fluid 160 in cavity 161, for example) or allow gases (e.g., air), water, or undesirable fluids to be withdrawn from cavity 161 while leaving the desirable fluid 160 in cavity 161. In addition, channel 162 may be used to supply or inject fluid 160 (or other fluid) into cavity 161. For example, fluid 160 may be pumped into cavity 161 when volume of fluid 161 in cavity 161 is low. By supplying and withdrawing fluid from cavity 161 via channel 162, the tolerances (e.g., axial distances) between bearing races 140, 150 may be increased or decreased, respectively, as desired. In certain cases, fluid 160 may be pumped into cavity 161 to axially move bearing races 140, 150 closer together, thereby reducing “play” in bearing 100. This may be helpful to compensate for wear in bearing 100, expansions or contractions of the bearing elements 130 due to temperature changes, or the like.

Channel 162 may also be used to measure the pressure of fluid 160 within cavity 161. This offers the potential to provide a simple, effective, and accurate means to measure the axial loads (e.g., weight) applied to fluid-supported thrust bearing 100. In FIG. 2, a pressure transducer or sensor 163 is schematically shown in fluid communication with channel 162 and cavity 161 to measure and monitor the pressure of fluid 160 in cavity 161.

Although channel 162 is shown extending through lower structure 120 to cavity 161 positioned between lower bearing race 150 and lower structure 120, in other embodiments, the channel in fluid communication with the fluid cavity (e.g., channel 162) may extend through the lower bearing race (e.g., race 150). Further, in embodiments including a fluid cavity positioned between the upper bearing race (e.g., race 140) and the upper structure (e.g., structure 110), a channel extending through the upper structure or upper bearing race may be provided to access the fluid cavity to supply or withdraw fluid from the cavity, to measure fluid pressure within the cavity, or combinations thereof.

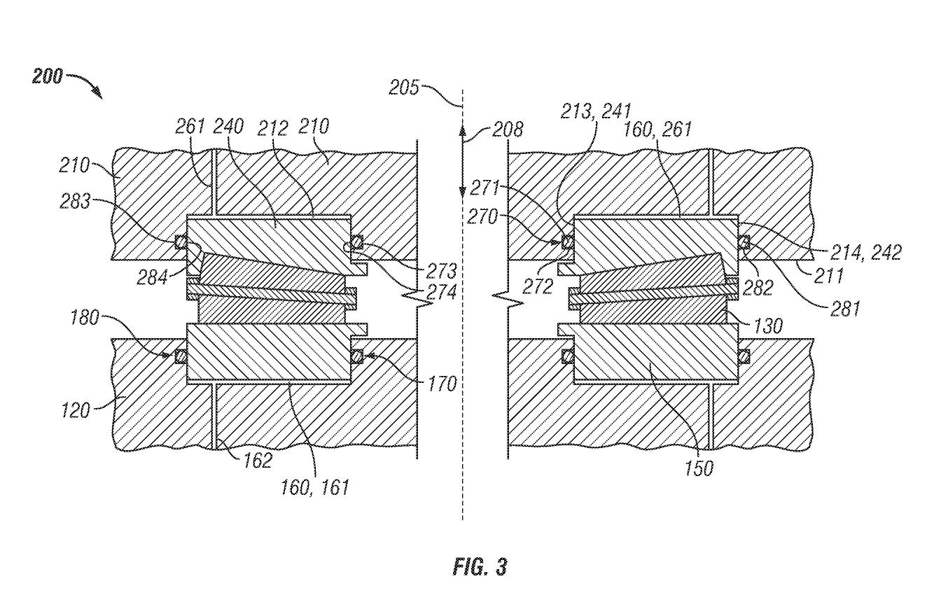

As shown in FIG. 1 and described above, cavity 161 and fluid 160 therein are positioned between lower bearing race 150 and lower structure 120, and thus, lower bearing race 150 floats or rides on fluid 160. However, in other embodiments, a fluid filled annular cavity may be positioned between each bearing race and its corresponding structure. For example, referring now to FIG. 3, an embodiment of a fluid-supported thrust bearing 200 in accordance with the principles described herein is shown. Thrust bearing 200 is similar to thrust bearing 100 previously described. Namely, thrust bearing 200 allows a first or upper structure 210 to rotate relative to second or lower structure 120 as previously described about an axis of rotation 205 while simultaneously supporting axial loads 208 between structures 210, 120. In addition, thrust bearing 200 includes a plurality of circumferentially spaced roller elements 130 as previously described, a first or upper annular race 240, and a second or lower annular race 150 as previously described. Upper race 240 is axially disposed between upper structure 210 and roller elements 130, and axially supports upper structure 210, and lower race 150 is axially disposed between lower structure 120 and roller elements 130, and is axially supported by lower structure 120. Roller elements 130 contact and roll along races 240, 150.

Lower structure 120 and lower bearing race 150 are configured as described above. Namely, lower bearing race 150 floats or rides on fluid 160 disposed in an annular cavity or cavity 161 axially disposed between lower bearing race 150 and structure 120. However, unlike thrust bearing 100 previously described, in this embodiment, upper structure 210 floats or rides on fluid 160 positioned between upper bearing race 240 and upper structure 210. In particular, fluid 160 resides in an annular cavity or cavity 261 axially disposed between upper bearing race 240 and upper structure 210. Upper structure 210 has an outer surface 211 opposed lower structure 120 that includes an annular recess 212 extending radially from a radially inner cylindrical surface 213 to a radially outer cylindrical surface 214. Upper bearing race 240 is at least partially disposed in recess 212 and slidingly engages surfaces 213, 214. In other words, upper bearing race 240 has a radially inner cylindrical surface 241 that slidingly engages surface 213 and a radially outer cylindrical surface 242 that slidingly engages surface 214. Fluid 160 is disposed in recess 212 axially between upper bearing race 240 and upper structure 210. Thus, bearing race 240 and structure 110 are designed and configured to form annular cavity 261 therebetween. Since fluid 160 in each cavity 161, 261 is flowable and defomable (i.e., fluid 160 is not a rigid solid), fluid 160 offers the potential to more evenly distribute forces between structures 210, 120 and corresponding bearing races 240, 150, respectively, thereby reducing and/or eliminating “hot spots.”

As previously described, in this embodiment, upper race 240 axially supports upper structure 210, and lower race 150 is axially supported by lower structure 120. In particular, axial loads 108 are transferred between upper race 240 and upper structure 210 through fluid 160 in cavity 261, and axial loads 108 are transferred between lower race 150 and lower structure 120 through fluid 160 in cavity 161. When the axial load 108 is a downward force (e.g., weight) acting on upper structure 210, the axial load 108 is transferred from upper structure 210 to upper bearing race 240 through fluid 160 in fluid cavity 261, then transferred from upper bearing race 240 to lower bearing race 150 through roller elements 130, and then transferred from lower bearing race 150 to lower structure 120 through fluid 160 in fluid cavity 161.

Referring still to FIG. 3, a pair of seal assemblies 170, 180 as previously described are provided to restrict and/or prevent fluid 160 in cavity 161 from flowing axially between bearing race 150 and structure 120. In addition, a pair of seal assemblies 270, 280 are provided to restrict and/or prevent fluid 160 in cavity 261 from flowing axially between bearing race 240 and structure 210. Seal assemblies 270, 280 are similar to seal assemblies 170, 180, respectively, as previously described. More specifically, first or radially inner sealing assembly 270 is provided between upper bearing race 210 and upper structure 210, and second or radially outer sealing assembly 280 is provided between upper bearing race 210 and upper structure 210. In this embodiment, each seal assembly 270, 280 includes an annular seal member 271, 281, respectively, seated in an annular seal gland or recess 272, 282, respectively, in upper structure 210. Gland 272 extends radially inward from surface 213, and gland 282 extends radially outward from surface 214. Seal member 271 is disposed in gland 272 and is radially compressed between bearing race 240 and structure 210, thereby forming an annular static seal 273 with structure 210 and an annular dynamic seal 274 with bearing race 240. Seal member 281 is disposed in gland 282 and is radially compressed between bearing race 240 and structure 210, thereby forming an annular static seal 283 with structure 210 and an annular dynamic seal 284 with bearing race 240. Thus, each seal member 271, 281 sealingly engages lower bearing race 240 and structure 210. In this embodiment, each seal member 271, 281 is an O-ring seal. However, in other embodiments, one or both seal members 271, 281 may comprise an energized U-cup hydraulic seal or other suitable hydraulic seal.

Although annular seal members 171, 181 are seated in glands 122, 132 in structure 120 in this embodiment, and seal members 271, 281 are seated in glands 272, 282 in structure 210, in other embodiments, the lower seal members (e.g., seal members 171, 181) may be seated in glands formed on the radially inner and radially outer surfaces, respectively, of the lower bearing race (e.g., surfaces 151 and 152 of bearing race 150) and/or the upper seal members (e.g., seal members 271, 281) may be seated in glands formed on the radially inner and radially outer surfaces, respectively, of the upper bearing race (e.g., surfaces 241 and 242 of bearing race 240). In such embodiments, an annular static seal is formed between each lower seal member and the lower bearing race, a dynamic seal is formed between each lower seal member and the lower structure, an annular static seal is formed between each upper seal member and the upper bearing race, a dynamic seal is formed between each upper seal member and the upper structure.

In the embodiment shown in FIG. 3, flow channel 162 as previously described is provided to access cavity 161, and a flow channel 261 is provided to access cavity 261. Each channel 162, 262 may be employed to bleed fluid(s) from cavity 161, 261, respectively, supply fluid to cavity 161, 261, respectively, monitor the fluid pressure within cavity 161, 261, respectively, or combinations thereof.

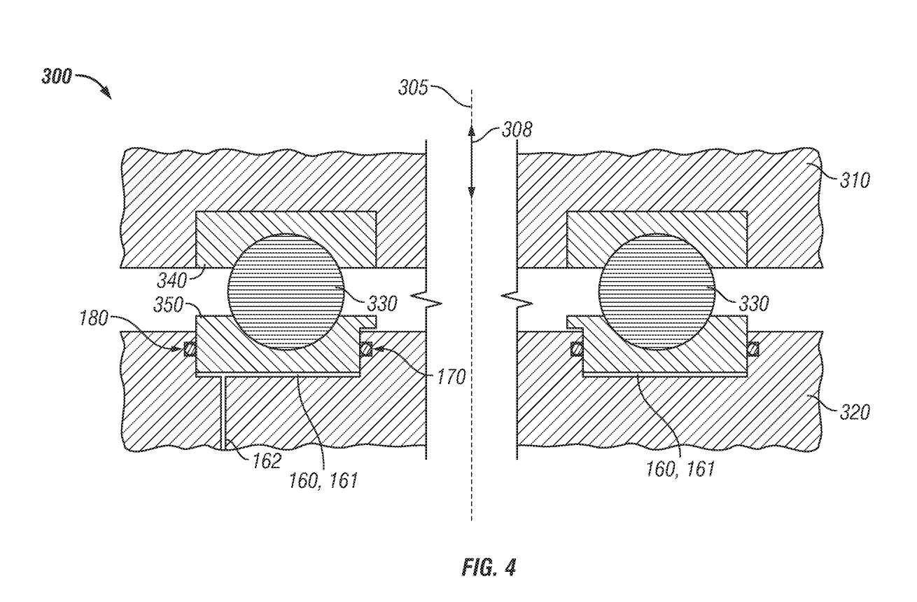

In thrust bearings 100, 200 previously described, each roller element 130 is a tapered roller element having an axis of rotation 135 oriented at an acute angle α relative to axis 105, 205 and a frustoconical radially outer surface 131. However, in other embodiments, the roller elements may be ball bearings or cylinders. For example, in FIG. 4, an embodiment of a fluid-supported thrust bearing 300 including ball bearing roller elements 330 is shown. Bearing 300 allows rotation of a first or upper structure 310 relative to a second or lower structure 320 about a an axis of rotation 305 while supporting axial loads 308. Thrust bearing 300 is the same as thrust bearing 100 previously described with the exception that thrust bearing 300 includes a plurality of circumferentially-spaced ball bearing roller elements 330. In particular, thrust bearing 300 includes a first or upper bearing race 340 that supports upper structure 310, a second or lower bearing race 350 that is supported by lower structure 320, and roller elements 330 axially disposed therebetween. Lower bearing race 350 floats or rides on fluid 160 disposed in cavity 161.

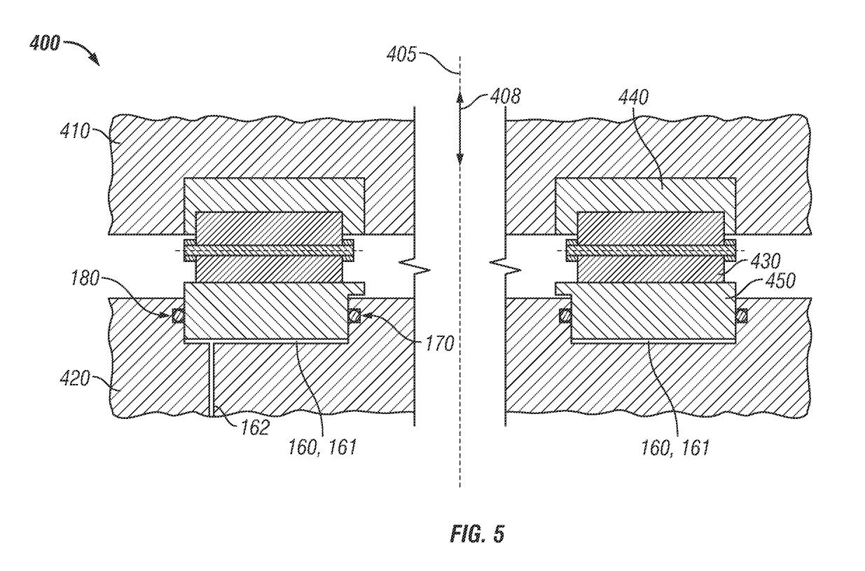

In FIG. 5, an embodiment of a fluid-supported thrust bearing 400 including cylindrical roller elements 430 is shown. Bearing 400 allows rotation of a first or upper structure 410 relative to a second or lower structure 420 about a an axis of rotation 405 while supporting axial loads 408. Thrust bearing 400 is the same as thrust bearing 100 previously described with the exception that thrust bearing 400 includes a plurality of circumferentially-spaced cylindrical roller elements 430. In particular, thrust bearing 400 includes a first or upper bearing race 440 that supports upper structure 410, a second or lower bearing race 450 that is supported by lower structure 420, and roller elements 430 axially disposed therebetween. Lower bearing race 450 floats or rides on fluid 160 disposed in cavity 161.

In the embodiments shown and described, certain features are illustrated in select embodiments. For example, in thrust bearings 100, 300, 400, only one bearing race is fluid supported; in thrust bearings 100, 200, tapered roller elements are employed; in thrust bearing 300, ball bearing roller elements are employed; in thrust bearing 400, cylindrical roller elements are employed; in thrust bearing 200, both bearing races are fluid supported; access is provided to the fluid cavity supporting a bearing race of thrust bearing 300, 400; the seal members sealingly engage the fluid supported bearing race of thrust bearing 100 are disposed in seal glands in the corresponding structure; a pressure transducer is provided to measure the fluid pressure in the fluid cavity supporting the bearing race of thrust bearing 100; etc. However, it should be appreciated that any one or more disclosed features may be employed in any one or more embodiments described herein, and further, any combination of disclosed features may be combined in any one or more embodiments described herein.

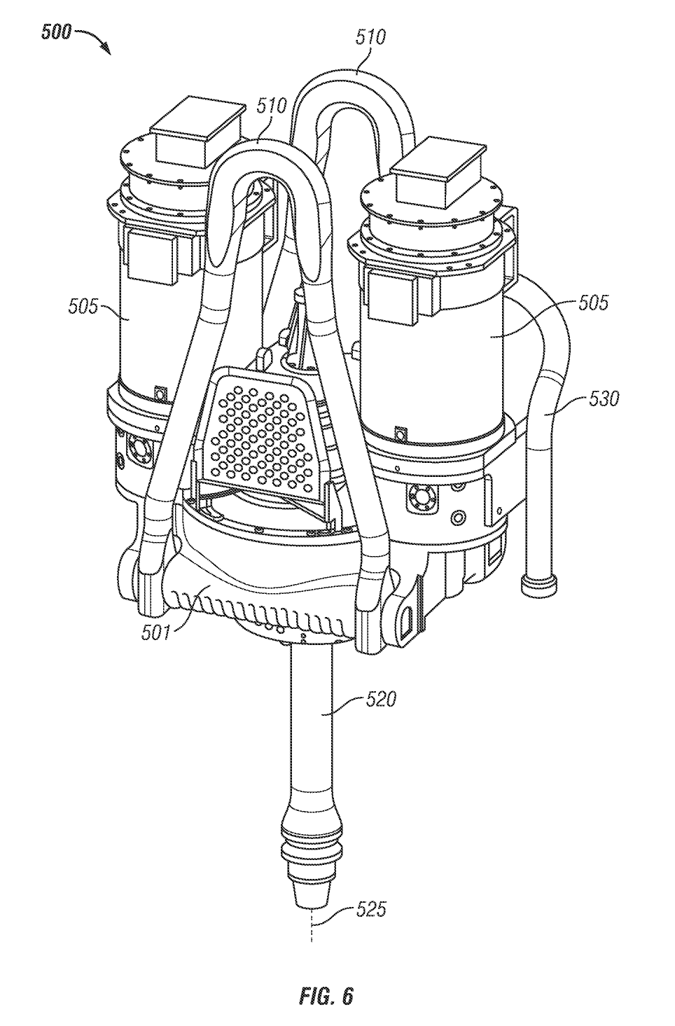

Referring now to FIG. 6, a device 500 including fluid-supported thrust bearing 100 previously described is shown. Device 500 is provided only by way of example and is not intended to be limiting. Indeed, embodiments of fluid-supported thrust bearings described herein (e.g., fluid-supported thrust bearings 100, 200, 300, 400) may be used in a wide variety of different devices in various applications. Nevertheless, one exemplary device 500 is provided to illustrate one possible implementation of the embodiments of fluid-supported thrust bearings described herein.

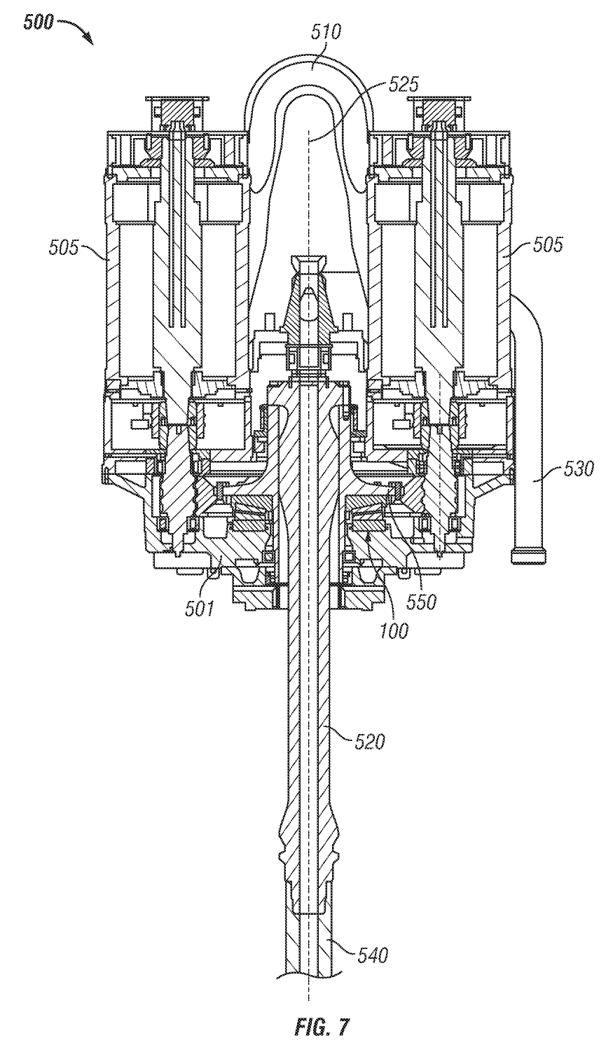

In the illustrated example, device 500 is a top-drive unit for rotating and supporting a drill string used in the oil and gas industry. Such a top drive unit 500 may be used in place of a conventional rotary table. As best shown in FIGS. 6 and 7, top drive unit 500 includes a base or main body 501, a pair of motors 505 coupled to body 501, a pair of bails 510 coupled to body 501, a main shaft 520 rotatably coupled to body 501, and a drilling fluid conduit 530 in fluid communication with main shaft 520. During drilling operations, a drill string 540 is hung from the lower end of shaft 520. Body 501 provides the overall support structure for top drive unit 500. Motors 505 drive the rotation of shaft 520 about its longitudinal or central axis 525, thereby driving the rotation of drill string 540. In this embodiment, inclusion of two motors 505 provides redundancy and ensures that shaft 520 and drill string 540 can continue to be rotated if one motor 505 fails. Bails 510 support the weight of top drive unit 500 as well as the weight of the drill string 540 coupled thereto. During drilling operations, bails 510 are preferably attached to a block or other pulley system to raise and lower top drive unit 500 and drill string 540. Conduit 530 supplies drilling fluid to the drill string 540 via shaft 520. In other words, conduit 530 is in fluid communication with shaft 520, which is in fluid communication with drill string 540.

Referring now to FIGS. 7-9, cross-sectional views of top drive unit 500 are shown. As previously described, top drive unit 500 includes body 501, motors 505, bails 510, conduit 530, and main shaft 520. In addition, a drive quill 550 resides inside main body 501 and is rotated about axis 525 relative to main body 501 by motors 505. Drive quill 550 is coupled to shaft 520 and supports the weight of shaft 520 as well as drill string 540 extending therefrom. To support the weight of drill string 540, which may be thousands of feet long, while allowing drive quill 550 to rotate with respect to main body 501, fluid-supported thrust bearing 100 as previously described is positioned between drive quill 550 and main body 501.

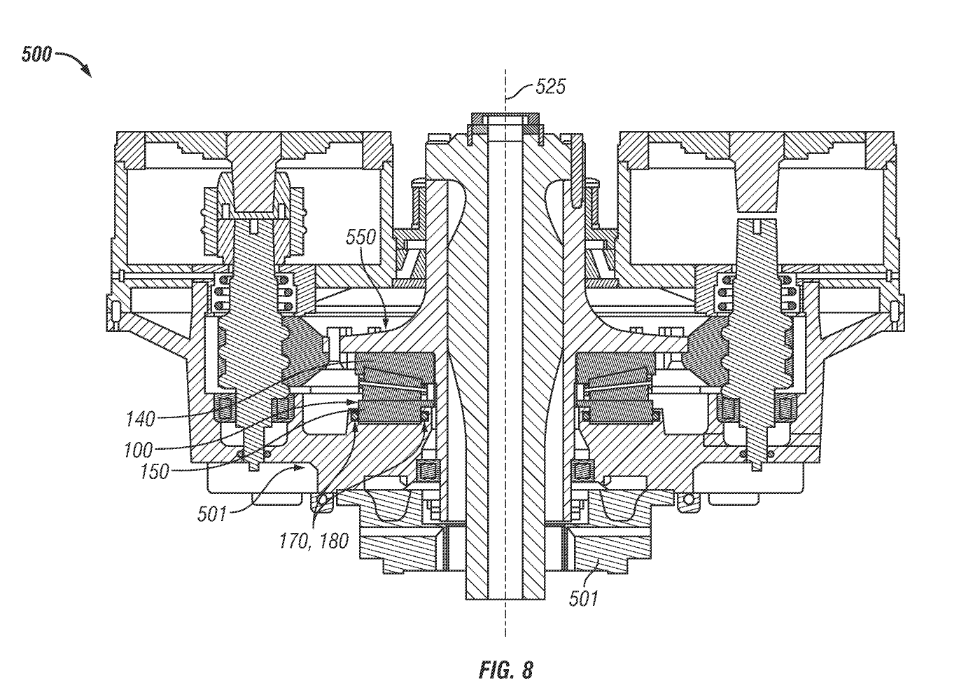

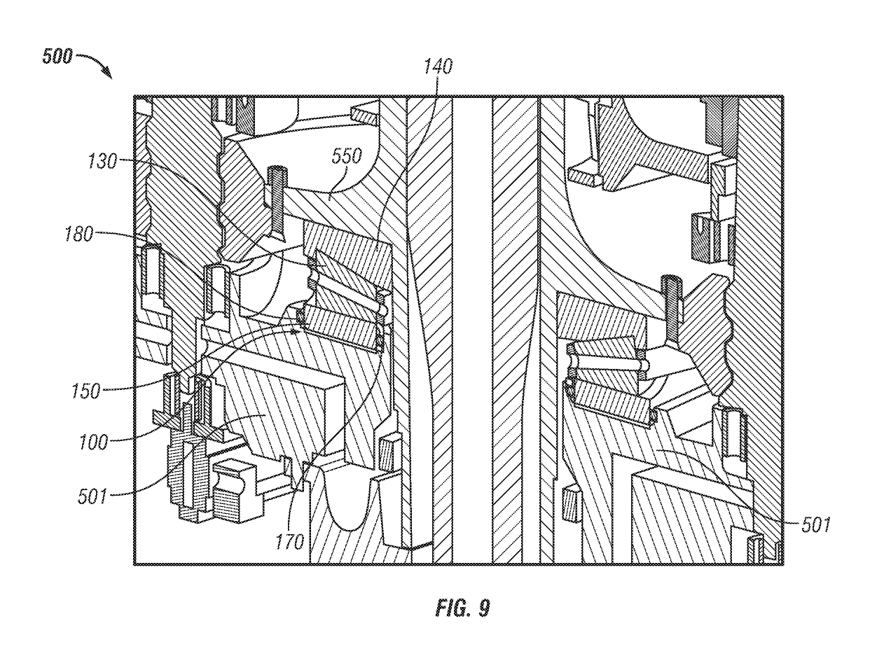

As best shown in FIGS. 8 and 9, in this embodiment, lower structure 120 comprises main body 501, and upper structure 110 comprises drive quill 550. Further, annular recess 122 is formed in the surface of main body 501 axially opposed drive quill 550, and annular lower bearing race 150 is slidingly disposed therein. Annular upper bearing race 140 is urged axially into engagement with drive quill 550. Seal assemblies 170, 180 are positioned radially between main body 501 and lower bearing race 150 to restrict and/or prevent fluid 160 contained within cavity 161 from flowing axially between lower bearing race 150 and main body 501. Fluid 160 with cavity 161 offers the potential to reduce and/or prevent “hot spots” from forming in thrust bearing 100 when main body 501 and/or drive quill 550 deflect or deform under load. A pressure transducer or sensor (e.g., pressure transducer 163) may be placed in fluid communication with cavity 161 (e.g., by inclusion of a flow channel or passage similar to passage 162 previously described) to measure the pressure in cavity 161, which may be used to calculate the axial load on bearing 100. Without being limited by this or any particular theory, the axial load on bearing 100 is equal to the fluid pressure in cavity 161 multiplied by the surface area of lower bearing race 140 that contacts fluid 160 within cavity 161. In this embodiment, the axial load is representative of the weight of drive quill 550, main shaft 520, drill string 540 and any other downhole components hung from drill string 540. This method offers the potential for a more accurate, simple, and cost-effective means for determining the axial loads on bearing 100 as compared to conventional weight-measurement techniques.

In the manner described, embodiments described herein disclose fluid-supported thrust bearings (e.g., thrust bearings 100, 200, 300, 400) that support axial loads between two structures while allow relative rotation between the structures. The disclosed embodiments include roller elements disposed between two bearing races. One or both of the bearing races float or ride on a fluid that offers the potential facilitate the even distribution of forces across the bearing when the two structures deflect relative to each other, thereby reducing the occurrence and/or severity of “hot spots,” which may otherwise lead to premature bearing wear and failure. As a result, embodiments described herein may enable the structures to be designed with lesser consideration for deflection, potentially significantly reducing weight and cost.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. In addition, although certain features are illustrated in select embodiments, it should be appreciated that various features described herein may be included in any embodiment. Accordingly, the scope of protection is not limited to the embodiments described herein, but is only limited by the claims that follow, the scope of which shall include all equivalents of the subject matter of the claims.

What is claimed is:

1. A thrust bearing for allowing a first structure to rotate relative to a second structure about an axis of rotation while supporting an axial load between the first structure and the second structure, the thrust bearing comprising:
a first annular bearing race slidingly disposed in a first annular recess in the first structure;
a second annular bearing race engaging the second structure;
a plurality of circumferentially spaced roller elements axially disposed between the first bearing race and the second bearing race, wherein the roller elements contact the first bearing race and the second bearing race;
wherein the first bearing race and the first recess define a first annular fluid cavity axially positioned between the first bearing race and the first structure;
wherein the first bearing race rides on a fluid disposed in the first fluid cavity.

2. The thrust bearing of claim 1, wherein the roller elements are tapered roller elements, cylindrical roller elements, or ball bearing roller elements.

3. The thrust bearing of claim 1, further comprising a first annular seal assembly radially positioned between a radially inner surface of the first bearing race and the first structure and a second annular seal assembly radially positioned between a radially outer surface of the first bearing race and the first structure, wherein the first seal assembly and the second seal assembly are configured to restrict the fluid in the first fluid cavity from flowing axially between the first bearing race and the first structure.

4. The thrust bearing of claim 3, wherein the first recess includes a radially inner annular surface opposed the radially inner surface of the first bearing race and a radially outer annular surface opposed the radially outer surface of the first bearing race;
wherein the first seal assembly comprises a first annular seal member disposed in a first annular seal gland formed in the radially inner surface of the first recess and the second seal assembly comprises a second annular seal member disposed in a second annular seal gland formed in the radially outer surface of the first recess.

5. The thrust bearing of claim 4, wherein the first annular seal member and the second annular seal member each form an annular static seal with the first structure and an annular dynamic seal with the first bearing race.

6. The thrust bearing of claim 1, wherein the second annular bearing race is slidingly disposed in a second annular recess in the second structure;
wherein a fluid disposed in the recess axially between the second bearing race and the second structure.
wherein the second bearing race and the second recess define a second annular fluid cavity axially positioned between the second bearing race and the second structure;
wherein the second bearing race rides on a fluid disposed in the second fluid cavity.

7. The thrust bearing of claim 6, further comprising a third annular seal assembly radially positioned between a radially inner surface of the second bearing race and the second structure and a fourth annular seal assembly radially positioned between a radially outer surface of the second bearing race and the second structure, wherein the third seal assembly and the fourth seal assembly are configured to restrict the fluid in the second fluid cavity from flowing axially between the second bearing race and the second structure.

8. The thrust bearing of claim 1, wherein the fluid is a hydraulic fluid.

9. An apparatus, comprising:
a first structure;
a second structure rotatably coupled to the first structure, wherein the second structure is adapted to rotate relative to the first structure about an axis of rotation;
a thrust bearing axially disposed between the first structure and the second structure, wherein the thrust bearing comprises:
a plurality of circumferentially-spaced roller elements disposed about the axis of rotation; and
a first bearing race in contact with the plurality of roller elements;
a first fluid cavity axially disposed between the first structure and the first bearing race; and
a fluid in the first fluid cavity configured to transfer axial loads between the first structure and the first bearing race.

10. The apparatus of claim 9, further comprising a first annular seal assembly radially positioned between the first structure and the first bearing race and a second annular seal assembly radially positioned between the first structure and the first bearing race, wherein the first seal assembly and the second seal assembly are each configured to restrict the flow of fluid from the first fluid cavity.

11. The apparatus of claim 10, wherein the first seal assembly is disposed along a radially inner surface of the first bearing race, and the second seal assembly is disposed along a radially outer surface of the first bearing race.

12. The apparatus of claim 9, wherein the first structure axially supports the first bearing race.

13. The apparatus of claim 9, wherein the first bearing race axially supports the first structure.

14. The apparatus of claim 9, wherein the roller elements are ball bearings, cylindrical roller bearings, or tapered roller bearings.

15. The apparatus of claim 9, further comprising a flow channel in fluid communication with the first fluid cavity.

16. The apparatus of claim 15, further comprising a pressure transducer in fluid communication with the flow channel.

17. The apparatus of claim 9, wherein the first structure is a drive quill of a top drive and the second structure is a body of a top drive.

18. A method for supporting an axial load between a first structure and a second structure and allowing the first structure to rotate relative to the second structure about an axis of rotation, the method comprising:
(a) placing a thrust bearing axially between the first structure and the second structure, wherein the thrust bearing comprises:
a first annular bearing race axially adjacent the first structure;
a second annular bearing race axially adjacent the second structure;
a plurality of circumferentially spaced roller elements axially disposed between the first bearing race and the second bearing race, wherein the roller elements contact the first bearing race and the second bearing race;
(b) forming an annular fluid cavity axially between the first bearing race and the first structure;
(c) filling the fluid cavity with a fluid; and
(d) transferring the axial load between the first bearing race and the first structure through the fluid in the fluid cavity.

19. The method of claim 18, further comprising:
(e) restricting the fluid in the fluid cavity from leaking from the first fluid cavity during (d).

20. The method of claim 18, wherein (b) further comprises slidingly disposing the first annular bearing race within a first annular recess in the first structure.

21. The method of claim 18, wherein (d) further comprises transferring the axial load from the first bearing race to the first structure through the fluid in the fluid cavity.

22. The method of claim 18, wherein (d) further comprises transferring the axial load from the first structure to the first bearing race through the fluid in the fluid cavity.
